(19) United States
(12) Patent Application Publication
(10) Pub. No.: US 2022/0340771 A1
(43) Pub. Date: Oct. 27, 2022

(54) INKJET TEXTILE PRINTING INK

(71) Applicant: KYOCERA Document Solutions Inc., Osaka (JP)

(72) Inventor: Ryotaro KOMADA, Osaka-shi (JP)

(73) Assignee: KYOCERA Document Solutions Inc., Osaka (JP)

(21) Appl. No.: 17/725,216

(22) Filed: Apr. 20, 2022

(30) Foreign Application Priority Data
Apr. 22, 2021 (JP) 2021-072541

(51) Int. Cl. C09D 11/328; C09D 11/322; C09D 11/037; C09D 11/107; D06P 3/00; D06P 5/30

(52) U.S. Cl. CPC C09D 11/328; C09D 11/322; C09D 11/037; C09D 11/107; D06P 3/002; D06P 5/30

(57) ABSTRACT

An ink contains an aqueous medium, coloring particles dispersing in the aqueous medium, and a cross-linking agent having a carbodiimide group. The coloring particles contain a specific vinyl resin and a specific salt compound containing a dye. The specific vinyl resin includes a specific repeating unit derived from a specific monomer having a carboxy group. The specific vinyl resin has an acid value of at least 50 mg KOH/g and no greater than 150 mg KOH/g. The specific vinyl resin has a glass transition point of at least 50° C. and no higher than 80° C. The ink does not contain a free resin dispersing or dissolving in the aqueous medium or has a percentage content of the free resin of greater than 0.00% by mass and no greater than 0.50% by mass.

### INCORPORATION BY REFERENCE

The present application claims priority under 35 U.S.C. § 119 to Japanese Patent Application No. 2021-072541, filed on Apr. 22, 2021. The contents of this application are incorporated herein by reference in their entirety.

### BACKGROUND

The present disclosure relates to an inkjet textile printing ink.

An inkjet textile printing ink to be used in inkjet textile printing is required to be excellent in dispersibility and preservation stability, enable formation of an image with excellent image quality, and enable formation of a textile print with excellent color fastness to rubbing. Examples of the inkjet textile printing ink include an inkjet textile printing ink containing a pigment and a dispersant and an inkjet textile printing ink containing coloring particles containing a dye and a resin. Of the above inkjet textile printing inks, the inkjet textile printing ink containing coloring particles has advantages of exhibiting excellent color formability, not usually needing pre-treatment and post-treatment, and hardly causing nozzle clogging in ink ejection from a recording head. As an inkjet textile printing ink containing coloring particles, an inkjet textile printing ink is proposed that contains coloring particles containing an oil dye and a resin, for example.

### SUMMARY

An inkjet textile printing ink according to an aspect of the present disclosure contains an aqueous medium, coloring particles dispersing in the aqueous medium, and a first cross-linking agent having a carbodiimide group. The coloring particles contain a specific vinyl resin and a specific salt compound containing a dye. The specific vinyl resin includes a specific repeating unit derived from a specific monomer having a carboxy group. The specific vinyl resin has an acid value of at least 50 mg KOH/g and no greater than 150 mg KOH/g. The specific vinyl resin has a glass transition point of at least 50° C. and no higher than 80° C. The inkjet textile printing ink according to the aspect of the present disclosure does not contain a free resin dispersing or dissolving in the aqueous medium or has a percentage content of the free resin of greater than 0.00% by mass and no greater than 0.50% by mass. The inkjet textile printing ink according to the aspect of the present disclosure does not contain a free dye dispersing or dissolving in the aqueous medium or has a percentage content of the free dye of greater than 0.000% by mass and no greater than 0.050% by mass.

### DETAILED DESCRIPTION

The following describes an embodiment of the present disclosure. In the present specification, the term “(meth)acryl” may be used as a generic term for both acryl and methacryl. One type of each component described in the present specification may be used independently, or two or more types of the component may be used in combination.

Note that measurement values for volume median diameter (D₅₀) are values as measured using a dynamic light scattering type particle size distribution analyzer (“ZETASIZER NANO ZS”, product of Malvern Instruments Ltd.) unless otherwise stated.

Measurement values for acid value are values as measured in accordance with the method prescribed in “the Japanese Industrial Standards (JIS) K0070-1992” unless otherwise stated.

Measurement values of glass transition point (Tg) are values as measured in accordance with “the Japanese Industrial Standards (JIS) K7121-2012” using a differential scanning calorimeter (e.g., “DSC-60”, product of Shimadzu Corporation) unless otherwise stated. The glass transition point (Tg) corresponds to the temperature (specifically, a temperature at an intersection point of an extrapolated baseline and an extrapolated falling line) of a point of inflection caused by glass transition on a heat absorption curve (vertical axis: heat flow (DSC signal), horizontal axis: temperature, heating rate 5° C./min.) measured using the differential scanning calorimeter.

### Inkjet Textile Printing Ink

An inkjet textile printing ink (also referred to below as ink) according to an embodiment of the present disclosure contains an aqueous medium, coloring particles dispersing in the aqueous medium, and a first cross-linking agent having a carbodiimide group. The coloring particles contain a specific vinyl resin and a specific salt compound containing a dye. The specific vinyl resin includes a specific repeating unit derived from a specific monomer having a carboxy group. The specific vinyl resin has an acid value of at least 50 mg KOH/g and no greater than 150 mg KOH/g. The specific vinyl resin has a glass transition point of at least 50° C. and no higher than 80° C. The ink according to the present disclosure does not contain a free resin dispersing or dissolving in the aqueous medium or has a percentage content of the free resin of greater than 0.00% by mass and no greater than 0.50% by mass. The ink according to the present disclosure does not contain a free dye dispersing or dissolving in the aqueous medium or has a percentage content of the free dye of greater than 0.000% by mass and no greater than 0.050% by mass.

The ink of the present disclosure is used for textile-printing a textile printing target. The textile printing target to be printed with the ink of the present disclosure may be a woven fabric or a knitted fabric. Examples of the textile printing target include a cotton fabric, a silk fabric, a hemp fabric, an acetate fabric, a rayon fabric, a nylon fabric, a urethane fabric, and a polyester fabric. The textile printing target is preferably a polyester fabric.

A direct textile printing method (textile printing method in which an ink is directly ejected toward a textile printing target) will be described as an example of a textile printing method using the ink of the present disclosure. The direct textile printing method includes an image formation process of forming an image by ejecting the ink of the present disclosure toward an image formation area of a textile printing target and a heating process of heating the textile printing target after the image formation process. In the image formation process, an inkjet textile printing apparatus can be used that includes a recording head (e.g., a thermal recording head or a piezoelectric recording head), for example. The heating conditions in the heating process include a heating temperature of at least 150° C. and no greater than 220° C. and a heating time of at least 30 seconds and no greater than 120 seconds.

As a result of having the above features, the ink of the present disclosure is excellent in dispersibility and preservation stability. Further, with the ink of the present disclosure, images with excellent image quality can be formed and textile prints excellent in color fastness to rubbing can be formed. The reasons for the above are inferred as follows. The ink of the present disclosure contains coloring particles as a coloring component. The coloring particles contain a specific vinyl resin and a specific salt compound containing a dye. Many of salt-forming dyes that can be contained in the specific salt compound are more excellent in color formability than the other dyes (e.g., a self-disperse dye and an oil dye). Furthermore, the specific salt compound is excellent in affinity to the specific vinyl resin, and will highly disperse in the specific vinyl resin of the coloring particles to exhibit excellent color formability. From the above, clear images can be formed with the ink of the present disclosure.

Furthermore, when an ink is ejected from a recording head, a small amount of ink remains on the nozzle surface of the recording head. In a case in which the ink contains excessive amounts of a free resin and a free dye, the free resin and free dye precipitate and adhere to the nozzle surface once the ink remaining on the nozzle surface dries. This may serves as a cause of an image defect. By contrast, as a result of the ink of the present disclosure containing little or no free resin and free dye, occurrence of the above-described image defect can be inhibited. As described above, clear images can be formed and production of an image defect can be inhibited with use of the ink of the present disclosure. Accordingly, images excellent in image quality can be formed.

Furthermore, the specific vinyl resin contained in the coloring particles has a moderately high acid value (at least 50 mg KOH/g). Therefore, the coloring particles have excellent hydrophilicity, and highly disperses in the aqueous medium. From the above, the ink of the present disclosure is excellent in dispersibility.

Moreover, the specific vinyl resin contained in the coloring particles of the ink of the present disclosure has a moderately low glass transition point (Tg) (no greater than 80° C.). Therefore, when the aforementioned textile printing target toward which the ink of the present disclosure has been ejected is heated, the coloring particles becomes moderately soft to firmly attach to the textile printing target. Furthermore, the ink of the present disclosure contains the first cross-linking agent having a carbodiimide group. When the textile printing target toward which the ink of the present disclosure has been ejected is heated, the first cross-linking agent reacts with the carboxy group of the specific vinyl resin contained in the coloring particles to cross-link the coloring particles. As a result, the coloring particles further firmly attach to the surface of the textile printing target. The carboxy group of the specific vinyl resin has been included in the cross-linking structure. Accordingly, the coloring particles cross-linked by the first cross-linking agent have lower hydrophilicity than those before being cross-linked. As a result of the above, the coloring particles are not readily detached from the surface of the textile printing target even when the surface of the textile print formed with the ink of the present disclosure is rubbed in a dry state or a wet state. Therefore, a textile print with excellent color fastness to rubbing can be formed with the ink of the present disclosure.

By contrast, in a case in which the specific vinyl resin contained in the coloring particles has an excessively low glass transition point (Tg) (e.g., less than 50° C.), the coloring particles are soft even at normal temperature to decrease preservation stability of the ink. By contrast, the specific vinyl resin in the ink of the present disclosure has a glass transition point (Tg) of at least 50° C., which is not excessively low. Therefore, the ink of the present disclosure is excellent in preservation stability.

### Coloring Particles

The coloring particles contain a specific vinyl resin and a specific salt compound containing a dye. The specific vinyl resin in the coloring particles forms a matrix, for example. The specific salt compound in the coloring particles is present in a state of dispersing in the matrix formed by the specific vinyl resin, for example.

It is preferable that the coloring particles contain only the specific salt compound and the specific vinyl resin. However, the coloring particles may contain an additional component (e.g., a resin other than the specific vinyl resin, a colorant other than the dye, a later-described second cross-linking agent, a later-described neutralizer, and a later-described surfactant). The total percentage content of the specific salt compound and the specific vinyl resin in the coloring particles is preferably at least 70% by mass, more preferably at least 90% by mass, and further preferably at least 99% by mass.

The coloring particles have a volume median diameter D₅₀ of preferably at least 40 nm and no greater than 150 nm, and more preferably at least 80 nm and no greater than 120 nm. As a result of the volume median diameter D₅₀ of the coloring particles being set to at least 40 nm, agglomeration of the coloring particles can be inhibited. As a result of the volume median diameter D₅₀ of the coloring particles being set to no greater than 150 nm, performance of the ink of the present disclosure being ejected can be increased.

The content ratio of the specific salt compound relative to 100 parts by mass of the specific vinyl resin in the coloring particles is preferably at least 10 parts by mass and no greater than 80 parts by mass, and more preferably at least 20 parts by mass and no greater than 45 parts by mass. As a result of the content ratio of the salt compound being set to at least 10 parts by mass, images with desired image density can be easily formed with the ink of the present disclosure. As a result of the content ratio of the specific salt compound being set to no greater than 80 parts by mass, a textile print formed with the ink of the present disclosure can have further increased color fastness to rubbing.

The percentage content of the coloring particles in the ink of the present disclosure is preferably at least 1.0% by mass and no greater than 20.0% by mass, and more preferably at least 4.0% by mass and no greater than 10.0% by mass.

### Specific Salt Compound

The specific salt compound contains a dye. Examples of the dye contained in the specific salt compound include acid dyes and basic dyes. The dye included in the specific salt compound is preferably a basic dye.

Examples of the basic dyes include C.I. Basic Yellow (specifically, 1, 2, 11, 13, 14, 15, 19, 21, 23, 24, 25, 28, 29, 32, 36, 40, 41, 45, 49, 51, 53, 63, 465, 67, 70, 73, 77, 87, or 91), C.I. Basic Red (specifically, 2, 12, 13, 14, 15, 18, 22, 23, 24, 27, 29, 35, 36, 38, 39, 46, 49, 51, 52, 54, 59, 68, 69, 70, 73, 78, 82, 102, 104, 109, or 112), C.I. Basic Blue (specifically, 1, 3, 5, 7, 9, 21, 22, 26, 35, 41, 45, 47, 54, 62, 65, 66, 67, 69, 75, 77, 78, 89, 92, 93, 105, 117, 120, 122, 124, 129, 137, 141, 147, or 155), and C.I. Basic Black (specifically, 2 or 8).

Examples of the acid dyes include C.I. Acid Yellow (specifically, 17, 23, 42, 44, 79, or 142), C.I. Acid Red (specifically, 1, 8, 13, 14, 18, 26, 27, 35, 37, 42, 52, 82, 87, 89, 92, 97, 106, 111, 114, 115, 134, 186, 249, 254, or 289), C.I. Acid Blue (specifically, 9, 29, 45, 92, or 249), and C.I. Acid Black (specifically, 1, 2, 7, 24, 26, or 94).

The specific salt compound is commercially available under the name “metal complex dye” or “salt-forming dye”. Examples of commercially available specific slat compounds include “VALIFAST (registered Japanese trademark) BLACK Series (e.g., 1807, 1821, 3804, 3810, 3820, 3830, 3840, and 3870)”, “VALIFAST (registered Japanese trademark) BLUE Series (e.g., 1603, 1605, 1621, and 2620)”, “VALIFAST (registered Japanese trademark) GREEN 1501”, “VALIFAST (registered Japanese trademark) ORANGE 3209”, “VALIFAST (registered Japanese trademark) PINK 2310NN”, “VALIFAST (registered Japanese trademark) RED Series (e.g., 1308, 1320, 1355, 1364, 2320, 3304, 3306, 3311, 3312, and 3325)”, “VALIFAST (registered Japanese trademark) VIOLET Series (e.g., 1701 and 1704), and “VALIFAST (registered Japanese trademark) Yellow Series (e.g., 1108, 1151, 1171, 3120, 3150, 3170, 3180, 4120, and 4121)” (each are a compound produced by ORIENT CHEMICAL INDUSTRIES CO., LTD.).

The percentage content of the specific salt compound in the ink of the present disclosure is preferably at least 0.1% by mass and no greater than 4.0% by mass, and more preferably at least 0.3% by mass and no greater than 1.0% by mass. As a result of the percentage content of the specific salt compound being set to at least 0.1% by mass, images with desired image density can be easily formed with the ink of the present disclosure. As a result of the percentage content of the specific salt compound being set to no greater than 4.0% by mass, a textile print formed with the ink of the present disclosure can have further increased color fastness to rubbing.

### Specific Vinyl Resin

The specific vinyl resin includes a specific repeating unit derived from a specific monomer having a carboxy group. The specific repeating unit increases the acid value of the specific vinyl resin, and increases hydrophilicity of the coloring particles. Note that the specific vinyl resin may further include a repeating unit (also referred to below as additional repeating unit) derived from a monomer (also referred to below as additional vinyl monomer) not having a carboxy group.

Here, a vinyl resin refers to a resin including a repeating unit derived from a vinyl compound. The vinyl compound is a compound having a vinyl group (CH₂═CH—) or a group in which hydrogen in the vinyl group has been substituted. The vinyl compound is addition polymerized by carbon-to-carbon double bond (C═C) included in the vinyl group or the group in which hydrogen in the vinyl group has been substituted to form a vinyl resin.

Examples of the specific monomer include (meth)acrylic acid, vinyl benzoic acid, maleic acid, maleic acid monoalkyl ester, fumaric acid, itaconic acid, crotonic acid, cinnamic acid, and (meth)acrylic acid dimer.

The percentage content of the specific repeating unit in the specific vinyl resin is preferably at least 3.0% by mass and no greater than 30.0% by mass, and more preferably at least 7.0% by mass and no greater than 15.0% by mass. As a result of the percentage content of the specific repeating unit being set to at least 3.0% by mass, dispersibility of the ink of the present disclosure can be further increased. As a result of the percentage content of the specific repeating unit being set to no greater than 30.0% by mass, a textile print formed with the ink of the present disclosure can have further increased color fastness to rubbing.

Examples of the additional vinyl monomer include styrene compounds, (meth)acrylic acid alkyl esters, (meth)acrylic acid hydroxyalkyl esters, (meth)acrylic acid phenyl esters, (meth)acrylonitrile, and vinyl chloride.

Examples of the styrene compounds include styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene. A preferable styrene compound is styrene.

The percentage content of a repeating unit derived from a styrene compound in the specific vinyl resin is preferably at least 3.0% by mass and no greater than 40.0% by mass, and more preferably at least 20.0% by mass and no greater than 30.0% by mass.

Examples of the (meth)acrylic acid alkyl esters include methyl (meth)acrylate, ethyl (meth)acrylate, n-propyl (meth)acrylate, isopropyl (meth)acrylate, n-butyl (meth)acrylate, isobutyl (meth)acrylate. t-butyl (meth)acrylate, n-octyl (meth)acrylate, 2-ethylhexyl (meth)acrylate, stearyl (meth)acrylate, and lauryl (meth)acrylate. A preferable (meth)acrylic acid alkyl ester is n-butyl acrylate, methyl methacrylate, 2-ethylhexyl acrylate, or stearyl methacrylate.

The percentage content of a repeating unit derived from (meth)acrylic acid alkyl ester in the specific vinyl resin is preferably at least 20.0% by mass and no greater than 75.0% by mass, and more preferably at least 30.0% by mass and no greater than 45.0% by mass.

Examples of the preferable (meth)acrylic acid hydroxyalkyl esters include 2-hydroxyethyl (meth)acrylate.

The percentage content of a repeating unit derived from (meth)acrylic acid hydroxyalkyl ester in the specific vinyl resin is preferably at least 3.0% by mass and no greater than 10.0% by mass.

Examples of the (meth)acrylic acid phenyl esters include phenyl (meth)acrylate and benzyl (meth)acrylate. A preferable (meth)acrylic acid phenyl ester is benzyl (meth)acrylate.

The percentage content of a repeating unit derived from (meth)acrylic acid phenyl ester in the specific vinyl resin is preferably at least 10.0% by mass and no greater than 50.0% by mass, and more preferably at least 25.0% by mass and no greater than 35.0% by mass.

Preferably, the specific vinyl resin is a resin including repeating units derived from monomers of any of the following combinations A to E.

Combination A: acrylic acid, styrene, n-butyl acrylate, methyl methacrylate, and benzyl methacrylate

Combination B: methacrylic acid, styrene, n-butyl acrylate, methyl methacrylate, and benzyl methacrylate

Combination C: acrylic acid, styrene, n-butyl acrylate, methyl methacrylate, benzyl methacrylate, and 2-ethylhexyl acrylate

Combination D: methacrylic acid, styrene, n-butyl acrylate, methyl methacrylate, and 2-hydroxyethyl methacrylate

Combination E: acrylic acid, methyl methacrylate, benzyl methacrylate, 2-hydroxyethyl methacrylate, and stearyl methacrylate

Preferably, the specific vinyl resin is a block copolymer of a first block (hydrophilicity block) including the specific repeating unit and a second block (i.e., a hydrophobic block including only an additional repeating units). The first block may further include an additional repeating unit. The percentage content of the specific repeating unit in the first block is preferably at least 25.0% by mass and no greater than 75.0% by mass, and more preferably at least 40.0% by mass and no greater than 60.0% by mass.

A ratio (100×molecular weight of first block/molecular weight of specific vinyl resin) of the molecular weight of the first block to the molecular weight of the specific vinyl resin is preferably at least 5.0% and no greater than 50.0%, and more preferably at least 15.0% and no greater than 25.0%.

The specific vinyl resin has an acid value of preferably at least 50 mg KOH/g and no greater than 150 mg KOH/g, and more preferably at least 60 mg KOH/g and no greater than 90 mg KOH/g. As a result of the acid value of the specific vinyl resin being set to at least 50 mg KOH/g, hydrophilicity of the coloring particles can be increased. Accordingly, dispersibility of the ink of the present disclosure can be increased. As a result of the acid value of the specific vinyl resin being set to no greater than 150 mg KOH/g, an excessive increase in hydrophilicity of the coloring particles can be inhibited. Accordingly, a textile print formed with the ink of the present disclosure can have increased color fastness to rubbing.

The specific vinyl resin has a glass transition point (Tg) of at least 50° C. and no greater than 80° C., and preferably at least 70° C. and no greater than 80° C. As a result of the specific vinyl resin having a glass transition point (Tg) of at least 50° C., excessive softening of the coloring particles at normal temperature can be inhibited. Accordingly, preservation stability of the ink of the present disclosure can be increased. As a result of the specific vinyl resin having a glass transition point (Tg) of no greater than 80° C., the coloring particles are firmly fixed to a textile printing target when the textile printing target toward which the ink of the present disclosure has been ejected is heated. Accordingly, a textile print formed with the ink of the present disclosure can have increased color fastness to rubbing.

The percentage content of the specific vinyl resin in the ink of the present disclosure is preferably at least 1.0% by mass and no greater than 15.0% by mass, and more preferably at least 3.0% by mass and no greater than 7.0% by mass. As a result of the percentage content of the specific vinyl resin being set to at least 1.0% by mass, a textile print formed with the ink of the present disclosure can have further increased color fastness to rubbing. As a result of the percentage content of the specific vinyl resin being set to no greater than 15.0% by mass, preservation stability of the ink of the present disclosure can be further increased.

### Aqueous Medium

The aqueous medium contained in the ink of the present disclosure is a medium containing water. The aqueous medium may function as a solvent or may function as a dispersion medium. Specific examples of the aqueous medium include an aqueous medium containing only water and an aqueous medium containing water and a water-soluble organic solvent.

### Water

The percentage content of the water in the ink of the present disclosure is preferably at least 30.0% by mass and no greater than 80.0% by mass, and more preferably at least 45.0% by mass and no greater than 65.0% by mass. As a result of the percentage content of the water being set to at least 30.0% by mass and no greater than 80.0% by mass, performance of the ink of the present disclosure being ejected can be increased.

### Water-Soluble Organic Solvent

Examples of the water-soluble organic solvent include glycol compounds, glycol ether compounds, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the glycol ether compounds include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

A preferable water-soluble organic solvent is glycerin or a glycol compound, and more preferably glycerin or propylene glycol.

The percentage content of the water-soluble organic solvent in the ink of the present disclosure is preferably at least 5.0% by mass and no greater than 40.0% by mass, and more preferably at least 10.0% by mass and no greater than 25.0% by mass.

### First Cross-Linking Agent

The first cross-linking agent has a carbodiimide group (—N═C═N—). The number of repeats of the carbodiimide group in the first cross-linking agent is at least 2 and no greater than 30, for example. Examples of the first cross-linking agent include aromatic polycarbodiimides, alicyclic polycarbodiimides, and aliphatic polycarbodiimides. Note that polycarbodiimide refers to a polymer having a carbodiimide group in its molecule. Examples of the aromatic polycarbodiimides include poly(4,4′-diphenylmethane carbodiimide), poly(p-phenylene carbodiimide), poly(m-phenylene carbodiimide), poly(diisopropylphenyl carbodiimide), and poly(triisopropylphenyl carbodiimide). Examples of the alicyclic polycarbodiimides include poly(dicyclohexylmethane carbodiimide). Examples of the aliphatic polycarbodiimides include poly(diisopropyl carbodiimide). Examples of a commercially available first cross-linking agent includes “CARBODILITE (registered Japanese trademark) E-01”, “CARBODILITE (registered Japanese trademark) E-02”, and “CARBODILITE (registered Japanese trademark) V-02” (each are a polycarbodiimide produced by Nisshinbo Holdings Inc.).

The percentage content of the first cross-linking agent in the ink of the present disclosure is preferably at least 0.5% by mass and no greater than 10.0% by mass, and more preferably at least 2.0% by mass and no greater than 5.0% by mass. As a result of the percentage content of the first cross-linking agent being set to no greater than 0.5% by mass, a textile print formed with the ink of the present disclosure can have further increased color fastness to rubbing. As a result of the percentage content of the first cross-linking agent being set to no greater than 10.0% by mass, preservation stability of the ink of the present disclosure can be further increased.

### Free Resin

The free resin disperses or dissolves in the aqueous medium. For example, the free resin is the specific vinyl resin that has not been included in the coloring particles in preparation of the coloring particles or the specific vinyl resin that has been eluted from the coloring particles. An ink that contains a free resin much may cause nozzle clogging. Therefore, it is preferable that the ink of the present disclosure contains as little free resin as possible. Specifically, the ink of the present disclosure does not contain the free resin or has a percentage content of the free resin of greater than 0.00% by mass and no greater than 0.50% by mass. In a case in which the ink of the present disclosure contains the free resin, preferably, the percentage content of the free resin is greater than 0.00% by mass and no greater than 0.35% by mass.

### Free Dye

The free dye disperses or dissolves in the aqueous medium. For example, the free dye is the specific salt compound that has not been included in the coloring particles in preparation of the coloring particles or the specific salt compound that has been eluted from the coloring particles. An ink that contains a free dye much may cause nozzle clogging. Therefore, it is preferable that the ink of the present disclosure contains no free dye. Specifically, the ink of the present disclosure does not contain the free dye or has a percentage content of the free dye of greater than 0.000% by mass and no greater than 0.050% by mass. In a case in which the ink of the present disclosure contains the free dye, preferably, the percentage content of the free dye is greater than 0.000% by mass and no greater than 0.030% by mass.

Note that each percentage content of the free resin and the free dye is measured according to methods described in Examples or methods equivalent thereto.

### Second Cross-Linking Agent

The second cross-linking agent is a block isocyanate. The second cross-linking agent serves as a component that cross-links the coloring particles or that cross-links the coloring particles and a textile printing target. As a result of the ink of the present disclosure containing the second cross-linking agent, a textile print formed with the ink of the present disclosure can have further increased color fastness to rubbing.

An example of the block isocyanate is a compound constituted by an isocyanate compound and a blocking agent for blocking an isocyanate group in the isocyanate compound. Examples of the isocyanate compound include aliphatic isocyanate compounds, aromatic isocyanate compounds, and urethane prepolymer. Examples of the blocking agent include alcohol compounds, amine compounds, imide compounds, imine compounds, urea compounds, mercaptan compounds, diaryl compounds, phenol compounds, active methylene compounds, oxime compounds, and lactam compounds.

Examples of a commercially available block isocyanate include “NBP-8730”, “NBP-211”, “MEIKANATE CX”, “SU-268A”, “DM-6400”, “MEIKANATE DM-3031CONC”, “MEIKANATE DM-35HC”, and “MEIKANATE TP-10” each produced by MEISEI CHEMICAL WORKS, LTD.

The percentage content of the second cross-linking agent in the ink of the present disclosure is preferably at least 0.1% by mass and no greater than 5.0% by mass, and more preferably at least 0.5% by mass and no greater than 2.0% by mass. As a result of the percentage content of the second cross-linking agent being set to at least 0.1% by mass, a textile print formed with the ink of the present disclosure can have further increased color fastness to rubbing. As a result of the percentage content of the second cross-linking agent being set to no greater than 5.0% by mass, preservation stability of the ink of the present disclosure can be increased.

### Neutralizer

Preferably, the ink of the present disclosure further contains a neutralizer. Examples of the neutralizer include basic compounds. Examples of the basic compounds include ammonia, amine compounds, alkali metal salts, and alkali earth metals. A preferable neutralizer is an amine compound.

Note that when a neutralizer in an ink used for textile printing remains in a textile print, color fastness to rubbing of the textile print tends to decrease. Therefore, the neutralizer is preferably a component that is highly volatile and that will volatilize through heating treatment in textile printing. In view of the foregoing, a preferable neutralizer is an amine compound, which is a component with excellent volatility. As a result of an amine compound being used as the neutralizer, a textile print formed with the ink of the present disclosure can have further increased color fastness to rubbing. Alternatively, as a result of an amine compound being used as the neutralizer, the ink of the present disclosure can have more increased preservation stability than an ink containing any other neutralizer.

Examples of the amine compounds include allylamine, isopropylamine, diisopropylamine, ethylamine, diethylamine, triethylamine, 2-ethylhexylamine, 3-ethoxypropylamine, diisobutylamine, 3-diethylaminopropylamine, tri-n-octylamine, t-butylamine, sec-butylamine, propylamine, methylaminopropylamine, dimethylaminopropylamine, n-propanolamine, butanolamine, 2-amino-4-pentanol, 2-amino-3 -hexanol, 5-amino-4-octanol, 3- amino-3 -methyl-2-butanol, monoethanolamine, N,N-dimethylethanolamine, isopropanolamine, neopentanolamine, diglycolamine, ethylene diamine, 1,3-diaminopropane, 1,2-diaminopropane, 1,6-diaminohexane, 1,9-diamino nonane, 1,12-diamio dodecane, dimer fatty acid diamine, 2,2,4-trimethylhexamethylenediamine, 2,2,4-trimethylhexamethylenediamine, hexamethylenediamine, N-aminoethyl piperazine, N-aminopropyl piperazine, N-aminopropyldipiperidipropane, and piperazine. A preferable amine compound is diisopropylamine or triethylamine.

Examples of the alkali metal salts include sodium hydroxide, potassium hydroxide, sodium carbonate, and potassium carbonate. A preferable alkali metal salt is sodium hydroxide.

The content ratio of the neutralizer in the ink of the present disclosure is preferably at least 0.5 parts by mass and no greater than 15.0 parts by mass to 100 parts by mass of the coloring particles, and more preferably at least 1.0 parts by mass and no greater than 8.0 parts by mass.

### Surfactant

Preferably, the ink of the present disclosure further contains a surfactant. The surfactant increases permeability (wettability) of the ink of the present disclosure to a recording medium. Examples of the surfactant include anionic surfactants, cationic surfactants, and nonionic surfactants. A preferable surfactant is a nonionic surfactant.

Examples of the nonionic surfactants include polyoxyethylene dodecyl ether, polyoxyethylene hexadecyl ether, polyoxyethylene nonylphenyl ether, polyoxyethylene sorbitan monooleate ether, sucrose monodecanoate, and ethylene oxide adduct of acetylene glycol. A preferable nonionic surfactant is ethylene oxide adduct of acetylene glycol.

In a case in which the ink of the present disclosure contains a surfactant, the percentage content of the surfactant in the ink of the present disclosure is preferably at least 0.05% by mass and no greater than 3.0% by mass, and more preferably at least 0.1% by mass and no greater than 0.5% by mass.

### Other Components

The ink of the present disclosure may further contain any known additives (specific examples include a solution stabilizer, an anti-drying agent, an antioxidant, a viscosity modifier, a pH adjuster, and an antifungal agent) as necessary.

### Ink Production Method

The ink of the present disclosure is produced for example by mixing a coloring particle dispersion, the aqueous medium, the first cross-linking agent, and an optional component (e.g., the second cross-linking agent, the neutralizer, and the surfactant) added as necessary using a stirrer. The mixing time is at least 1 minute and no greater than 30 minutes, for example. In production of the ink of the present disclosure, foreign matter and coarse particles may be removed using a filter (e.g., a filter with a pore size of 5 μm) after uniform mixing of each component.

The coloring particle dispersion contains the coloring particles and water. Preferably, the coloring particle dispersion further contains a neutralizer. The coloring particle dispersion preferably contains the free resin and the free dye as little as possible. When the free resin and the free dye are removed from the coloring particle dispersion as far as possible in production of the ink of the present disclosure, the ink can have low percentage contents of the free dye and the free resin.

### Coloring Particle Dispersion Preparation Method

An example of a method for preparing the coloring particle dispersion is a method including a first process, a second process, a third process, and a fourth process.

In the first process, the specific salt compound and the specific vinyl resin are mixed in an organic solvent. In the second process, the neutralizer is added to the resultant mixture obtained by the first process for neutralization. In the third process, the mixture after neutralization is made particles by phase inversion emulsification. In the fourth process, a dispersion obtained by the third process is filtered to obtain a coloring particle dispersion.

### First Process

In the present process, the specific salt compound and the specific vinyl resin are mixed in an organic solvent. The organic solvent may be methyl ethyl ketone, for example. The amount of the specific salt compound used relative to 100 parts by mass of the specific vinyl resin in the mixing is preferably at least 10 parts by mass and no greater than 80 parts by mass, and more preferably at least 20 parts by mass and no greater than 45 parts by mass. The mixing temperature is preferably at least 70° C. and no greater than 130° C.

### Second Process

In the present process, the neutralizer is added to the mixture obtained by the first process for neutralization to for example a pH of 6 to 8. In the present process, the neutralizer itself may be added to the above-described mixture or an aqueous solution containing the neutralizer may be added to the above-described mixture.

### Third Process

In the present process, the neutralized mixture is made particles by phase inversion emulsification. Specifically, in phase inversion emulsification, water is added to the neutralized mixture to precipitate coloring particles. Next, the organic solvent is distilled from the mixture from which the coloring particles have been precipitated, thereby obtaining a dispersion containing the coloring particles, the water, and the neutralizer. A given amount of a free dye and a given amount of a free resin are contained in the dispersion.

### Fourth Process

In the present process, the dispersion obtained by the third process is filtered to obtain a coloring particle dispersion. Through the present process, the free dye and the free resin can be removed from the dispersion obtained by the third process. As a result, the coloring particle dispersion can be obtained that has a low content ratio of the free dye and a low content ratio of the free resin. Note that the solid concentration of the coloring particle dispersion may be adjusted by adding water to the coloring particle dispersion after the present process.

The filter used for filtration in the present process has a pore size of preferably no greater than 0.5 μm, and more preferably no greater than 0.1 μm. Filtration is preferably repeated at least 7 times and no greater than 20 times.

Note that another example of the method for preparing the coloring particle dispersion may be a method in which the specific salt compound and the specific vinyl resin are kneaded and pulverized and the resultant pulverized product is dispersed in water.

### EXAMPLES

The following describes examples of the present disclosure. However, the present disclosure is not limited to the following examples.

### Specific Vinyl Resin Synthesis

Into a four-necked flask (reaction vessel) equipped with a nitrogen inlet tube, a thermometer, a condenser, and a stirrer, 30 parts by mass of methyl ethyl ketone, 10 parts by mass of acrylic acid, 10 parts by mass of methyl methacrylate, 0.6 parts by mass of 2,2′ -azobisisobutyronitrile, and 3.2 parts by mass of 2-(dodecylthiocarbonothioylthio)-2-methyl propionate were added. The reaction vessel was purged with a nitrogen gas. Thereafter, the contents of the reaction vessel were increased to 75° C. to cause a polymerization reaction of the contents for 3 hours. Through the above, a first block including the specific repeating unit (repeating unit derived from the acrylic acid) was formed. Thereafter, the contents of the reaction vessel were cooled to the room temperature. Thereafter, 60 parts by mass of methyl ethyl ketone, 25 parts by mass of styrene, 5 parts by mass of n-butyl acrylate, 20 parts by mass of methyl methacrylate, and 30 parts by mass of benzyl methacryalte were additionally added into the reaction vessel. The reaction vessel was purged with a nitrogen gas. Thereafter, the contents of the reaction vessel were increased to 75° C. to cause a polymerization reaction of the contents for 3 hours. Through the above, a second block not including the specific repeating unit was formed at the end of the first block. The reaction product was refined from the contents of the reaction vessel after the reaction, thereby obtaining a specific vinyl resin (P-1).

Specific vinyl resins (P-2) to (P-9) were synthesized according to the same method as that for synthesizing the specific vinyl resin (P-1) in all aspects other than change of each component to those shown in Table 1 below.

The following indicates abbreviations in Table 1 below. Note that the amount of use of methyl ethyl ketone in Table 1 below indicates a total of the amount of methyl ethyl ketone used in the formation of the first block and the amount of methyl ethyl ketone used in the formation of the second block.

AA: acrylic acid (specific monomer)

MAA: methacrylic acid (specific monomer)

St: styrene

nBA: n-butyl acrylate

MMA: methyl methacrylate

BzMA: benzyl methacrylate

HEA: 2-hydroxyethyl methacrylate

2EHA: 2-ethylhexyl acrylate

SMA: stearyl methacrylate

DSCTSMPA: 2-(dodecylthiocarbonothioylthio)-2-methyl propionate

AIBN: 2,2′-azobisisobutyronitrile

MEK: methyl ethyl ketone

### Acid Value Measurement

Each acid value of the specific vinyl resins (P-1) to (P-9) was measured by the following method in accordance with “the Japanese Industrial Standards (JIS) K0070-1992”. The measurement results are as shown below in Table 1. First, 1.0 g of a measurement target (any of the specific vinyl resins (P-1) to (P-9)) was weighted finely. The resultant weight of the measurement target was taken to be a mass M [g] of the measurement target. Next, 1.0 g of the measurement target and 25 mL of a solvent mixture (mass of tetrahydrofuran: mass of ethanol=2:1) of tetrahydrofuran and ethanol were added into a beaker and stirred. Next, neutralization titration was performed on the measurement target using an automatic titration and measurement system (“COM-2500”, product of HIRANUMA Co., Ltd.). As a titration solution, 0.1 mol/L of ethanol solution of KOH was used. The amount of the titration solution used for the neutralization of the measurement target was taken to be S [mL]. Besides, neutralization titration was performed on the above-described solvent mixture (blank measurement). The amount of the titration solution used for the neutralization of the solvent mixture was taken to be B [mL]. The acid value of the measurement target was calculated using the following formula. Note that f in the following formula represents a factor indicating a ratio (actual concentration/catalog concentration) of the actual concentration to the catalog concentration of the titration solution.

Acid value [mg KOH/g]=(S−B)×f×5.61/M

### Measurement of Glass Transition Point (Tg)

Each glass transition point (Tg) of the specific vinyl resins (P-1) to (P-9) was measured by the method described in the embodiment in accordance with “the Japanese Industrial Standards (JIS) K0070-1992”. The measurement results are as shown below in Table 1.

TABLE 1

| | | | P-1 | P-2 | P-3 | P-4 | P-5 | P-6 | P-7 | P-8 | P-9 |
|---|---|---|---|---|---|---|---|---|---|---|---|
| Amount of use | First | AA | 10 | — | 17 | — | 15 | 22 | 3 | 8 | — |
| [part by mass] | block | MAA | — | 10 | — | 12 | — | — | — | - | 15 |
| | | MMA | 10 | 10 | 10 | 10 | 10 | 10 | 10 | 10 | 10 |
| | Second | St | 25 | 15 | 5 | 33 | — | 23 | 45 | 45 | 20 |
| | block | nBA | 5 | 7 | 10 | 10 | — | 10 | 10 | — | 20 |
| | | MMA | 20 | 28 | 33 | 30 | 20 | 15 | 32 | 25 | 20 |
| | | BzMA | 30 | 30 | 20 | — | 30 | 20 | — | 12 | 10 |
| | | HEA | — | — | — | 5 | — | — | — | — | — |
| | | 2EHA | — | — | 5 | — | 5 | — | — | — | 5 |
| | | SMA | — | — | — | — | 20 | — | — | — | — |

| | | | | | | | | | |
|---|---|---|---|---|---|---|---|---|---|
| DSCTSMPA | 3.2 | 3.2 | 3.2 | 3.2 | 3.2 | 3.2 | 3.2 | 3.2 | 3.2 |
| AIBN | 0.6 | 0.6 | 0.6 | 0.6 | 0.6 | 0.6 | 0.6 | 0.6 | 0.6 |
| MEK | 90 | 90 | 90 | 90 | 90 | 90 | 90 | 90 | 90 |

| | | | | | | | | | |
|---|---|---|---|---|---|---|---|---|---|
| Acid value [mg KOH/g] | 78 | 65 | 133 | 78 | 117 | 171.6 | 23 | 62 | 96 |
| Tg [° C.] | 75 | 78 | 62 | 79 | 59 | 68 | 77 | 95 | 47 |

### Ink Preparation

Inks of Examples 1 to 12 and Comparative Examples 1 to 9 were prepared according to the following methods.

### Example 1

Into a four-necked flask equipped with a reflux cooling tube, a stirrer, and a thermocouple, 12 g of the specific vinyl resin (R-1) and 3 g of a specific salt compound (“VALIFAST (registered Japanese trademark) BLUE 1631”, product of ORIENT CHEMICAL INDUSTRIES CO., LTD., specific salt compound containing a basic dye) being a dye were added. Next, 50 g of methyl ethyl ketone was added into the flask and the contents of the flask were stirred at 40° C. and at 300 rpm for 30 minutes. Through the above, particles (volume median diameter: approximately 100 nm) in which the specific vinyl resin and the specific salt compound have been united were formed in the methyl ethyl ketone. Next, 10.7 g of a neutralizer (1N aqueous sodium hydroxide solution) was added to the contents of the flask for neutralization. After the neutralization, 130 g in total of ion exchange water was dripped into the flask at a speed of 5 mL/min. Thereafter, the contents of the flask were sufficiently stirred, thereby obtaining a dispersion. Thereafter, dispersion treatment at a pressure of 180 MPa was performed on the resultant dispersion 5 times using a wet type jet mill (“NANOVATER L-AS”, product of YOSHIDA KIKAI CO., LTD.). Next, the dispersion after the dispersion treatment was heated to 60° C. under reduced pressure to distill the methyl ethyl ketone. Next, filtration treatment using a tangential flow filtration apparatus (“LV CENTRAMATE TANGENTIAL FLOW SYSTEM”, product of Nihon Pall Ltd.) was performed on the dispersion after the distillation. The filtration treatment was performed at a flow rate of 150 mL/min. using a film of super porous membrane (pore size 0.1 μm). In the filtration treatment, the number of times of filtration was 10. Here, the number of times of filtration refers to a value calculated using “C×B/A” where A [mL] represents a volume of the dispersion before the filtration treatment, B [mL/min.] represents a flow rate (150 mL/min.), and C [min.] represents a time of the filtration treatment. For example, where the volume of the dispersion before the filtration treatment is 150 mL, the number of times of filtration when the treatment is performed for 1 minute is 1 and the number of times of filtration when the treatment is performed for 5 minutes is 5. Ion exchange water was added to the resultant filtrate after the filtration to adjust the concentration of the filtrate so that the solid content had a percentage content of 15% by mass. Through the above, a coloring particle dispersion (solid content 15% by mass) containing the coloring particles was obtained.

Next, 20.0 g of the above-described coloring particle dispersion (containing 3.0 g of the coloring particles), 4.0 g of propylene glycol, 4.0 g of glycerin, 0.1 g of a nonionic surfactant (“SURFYNOL (registered Japanese trademark) 104”, product of Nissin Chemical Industry Co., Ltd.), 8.0 g of ion exchange water, and 3.75 g of a first cross-linking agent (I-1) (“CARBODILITE (registered Japanese trademark) E-05”, product of Nisshinbo Chemical Inc.) being a cross-linking agent were mixed. The resultant mixture was filtered using a filter with a pore size of 5 μm. Through the above, an ink of Example 1 was obtained. Note that in the filtration treatment, the mass of the component (coarse particles not being filtered) remaining on the filter was measured for later-described evaluation of dispersibility.

### Examples 2 to 12 and Comparative Examples 1 to 9

Inks of Examples 2 to 12 and Comparative Examples 1 to 9 were prepared according to the same method as that for preparing the ink of Example 1 in all aspects other than changes in type and amount of the specific vinyl resin, the dye, and the neutralizer used in the coloring particle dispersion preparation, the number of times of filtration in the filtration treatment, and type and amount of the cross-linking agent used in the ink preparation to those shown in Tables 2 to 4 below. The following indicates abbreviations in Tables 2 to 4 below.

1631: “VALIFAST (registered Japanese trademark) BLUE 1631”, product of ORIENT CHEMICAL INDUSTRIES, Co., Ltd., specific salt compound containing a basic dye

613: “OIL BLUE 613”, product of ORIENT CHEMICAL INDUSTRIES, Co., Ltd., specific salt compound containing a basic dye

314: “OIL PINK 314”, product of ORIENT CHEMICAL INDUSTRIES, Co., Ltd., specific salt compound containing a basic dye

60: “Plast Red 8375-N”, product of ARIMOTO CHEMICAL Co., Ltd., disperse dye (Disperse Red)

NaOH: 1N aqueous sodium hydroxide solution

DIPA: diisopropylamine (amine compound)

TEA: triethylamine (amine compound)

First cross-linking agent (I-1): “CARBODILITE (registered Japanese trademark) E-05”, product of Nisshinbo Chemical Inc., effective component concentration 40% by mass, cross-linking agent having a carbodiimide group

First cross-linking agent (I-2): “CARBODILITE (registered Japanese trademark) V-02-L2”, product of Nisshinbo Chemical Inc., effective component concentration 40% by mass, cross-linking agent having a carbodiimide group

Second cross-linking agent (II-1): “MEIKANATE CX”, product of MEISEI CHEMICAL WORKS, LTD., block isocyanate

Second cross-linking agent (II-2): “SU-268A”, product of MEISEI CHEMICAL WORKS, LTD., block isocyanate

%: percentage content [% by mass] in ink

### Measurement of Free Resin and Free Dye

With respect to each of the inks of Examples 1 to 12 and Comparative Examples 1 to 9, each percentage content of a free resin and a free dye was measured according to the following methods. The measurement results are shown in Tables 2 to 4 below.

Ultracentrifugation treatment at 140,000 rpm was performed on a measurement target (any of the inks of Examples 1 to 12 and Comparative Examples 1 to 9) with a mass of A for 30 minutes using an ultracentrifuge (“HIMAK (registered Japanese trademark) CS150FNX”, product of Eppendorf Himac Technologies Co., Ltd.). Thereafter, a supernatant was collected. An absorbance (specifically, absorbance of a dye used for the measurement target preparation at its peak wavelength) of the supernatant was measured using a spectrophotometer (“U-3000”, product of Hitachi, Ltd.). The measured absorbance of the supernatant was fitted to a pre-plotted calibration curve to calculate a concentration of the dye in the supernatant. The calibration curve was plotted through measurement of each absorbance of a plurality of aqueous dye solutions (samples for calibration curve plotting) at mutually different concentrations. The dye contained in the supernatant corresponds to a free dye contained in the measurement target. A mass B of the dye contained in the supernatant was calculated using the following formula (1-1). The mass B of the dye corresponds to a mass of a free dye contained in the measurement target. A percentage content of the free dye in the measurement target was calculated using the following formula (1-2).

Mass B of dye in supernatant=mass of supernatant×concentration of dye in supernatant (1-1)

Percentage content of free dye in measurement target=100×mass B of dye/mass A of measurement target (1-2)

Next, the total amount of the supernatant was dried and a mass C of the resultant solid content was measured. The above-described solid content corresponds to a mixture of the free dye and the free resin contained in the measurement target. Therefore, a value (mass C of solid content−mass B of dye) obtained by subtracting the mass B of the dye from the mass C of the solid content corresponds to a mass of the free resin contained in the measurement target. A percentage content of the free resin in the measurement target was calculated using the following formula (1-3).

Percentage content of free resin in measurement target=100×(mass C of solid content−mass B of dye)/mass A of measurement target

TABLE 2

| | | Example | | | | | | | | |
|---|---|---|---|---|---|---|---|---|---|---|
| | | 1 | 2 | 3 | 4 | 5 | 6 | 7 | 8 | 9 |
| Specific vinyl | Type | P-1 | P-2 | P-3 | P-4 | P-5 | P-1 | P-2 | P-3 | P-1 |
| resin | g | 12.0 | 12.0 | 12.0 | 12.0 | 12.0 | 12.0 | 12.0 | 12.0 | 12.0 |
| Dye | Type | 1631 | 1631 | 613 | 1631 | 613 | 1631 | 1631 | 314 | 1631 |
| | g | 3.0 | 3.0 | 3.0 | 3.0 | 3.0 | 3.0 | 3.0 | 3.0 | 5.0 |
| Neutralizer | Type | NaOH | NaOH | NaOH | NaOH | NaOH | DIPA | TEA | NaOH | NaOH |
| | g | 10.70 | 11.80 | 9.38 | 10.60 | 10.00 | 1.10 | 1.10 | 9.38 | 8.50 |
| Filtration | Times | 10 | 10 | 10 | 10 | 10 | 10 | 10 | 10 | 10 |
| Free dye | % | 0.025 | 0.030 | 0.040 | 0.033 | 0.035 | 0.020 | 0.021 | 0.037 | 0.042 |
| Free resin | % | 0.35 | 0.40 | 0.48 | 0.41 | 0.44 | 0.32 | 0.30 | 0.46 | 0.35 |
| First cross- | Type | I-1 | I-1 | I-2 | I-1 | I-1 | I-2 | I-2 | I-1 | I-1 |
| linking agent | g | 3.75 | 5.00 | 5.00 | 3.75 | 3.75 | 5.00 | 5.00 | 3.75 | 3.75 |
| Second cross- | Type | — | — | — | — | — | — | — | — | — |
| linking agent | g | — | — | — | — | — | — | — | — | — |

TABLE 3

| | | Example | | | Comparative Example | | | | | |
|---|---|---|---|---|---|---|---|---|---|---|
| | | 10 | 11 | 12 | 1 | 2 | 3 | 4 | 5 | 6 |
| Specific vinyl | Type | P-3 | P-4 | P-4 | P-6 | P-7 | P-8 | P-9 | P-2 | P-3 |
| resin | g | 12.0 | 12.0 | 12.0 | 12.0 | 12.0 | 12.0 | 12.0 | 12.0 | 12.0 |
| Dye | Type | 613 | 1631 | 1631 | 1631 | 1631 | 1631 | 1631 | 1631 | 613 |
| | g | 3.0 | 3.0 | 3.0 | 3.0 | 3.0 | 3.0 | 3.0 | 6.0 | 3.0 |
| Neutralizer | Type | NaOH | NaOH | NaOH | NaOH | NaOH | DIPA | TEA | NaOH | NaOH |
| | g | 9.38 | 10.60 | 10.60 | 11.00 | 5.50 | 11.70 | 10.20 | 7.00 | 9.38 |
| Filtration | Times | 15 | 10 | 10 | 10 | 10 | 10 | 10 | 10 | 5 |
| Free dye | % | 0.025 | 0.028 | 0.028 | 0.030 | 0.005 | 0.030 | 0.035 | 0.070 | 0.047 |
| Free resin | % | 0.40 | 0.41 | 0.41 | 0.48 | 0.10 | 0.40 | 0.45 | 0.36 | 0.76 |
| First cross- | Type | I-2 | I-1 | I-2 | I-1 | I-1 | I-2 | I-1 | I-1 | I-2 |
| linking agent | g | 5.00 | 3.75 | 5.00 | 3.75 | 3.75 | 5.00 | 3.75 | 3.75 | 5.00 |
| Second cross- | Type | — | II-2 | II-1 | — | — | — | — | — | — |
| linking agent | g | — | 1.5 | 1.0 | — | — | — | — | — | — |

TABLE 4

Comparative Example

| | | 7 | 8 | 9 |
|---|---|---|---|---|
| Specific vinyl | Type | P-3 | P-1 | P-4 |
| resin | g | 12.0 | 12.0 | 12.0 |
| Dye | Type | 60 | 1631 | 1631 |
| | g | 3.0 | 3.0 | 3.0 |
| Neutralizer | Type | NaOH | NaOH | NaOH |
| | g | 9.38 | 10.70 | 10.60 |
| Filtration | Times | 10 | 10 | 10 |
| Free dye | % | 0.001 | 0.025 | 0.033 |
| Free resin | % | 0.48 | 0.35 | 0.41 |
| First cross- | Type | I-2 | — | — |
| linking agent | g | 5.00 | — | — |
| Second cross- | Type | — | — | II-1 |
| linking agent | g | — | — | 1.0 |

### Evaluation

With respect to each of the inks of Examples 1 to 12 and Comparative Examples 1 to 9, dispersibility, preservation stability, image quality of an image formed with the ink, and color fastness to rubbing (specifically, each of color fastness to dry rubbing and color fastness to wet rubbing) of a textile print formed with the ink were evaluated by the following methods. However, it was difficult to perform evaluation of those other than dispersibility on the ink of Comparative Example 2 due to the ink having low dispersibility (i.e., containing many coarse particles) and therefore only evaluation of dispersibility was performed on the ink. The evaluation results are shown below in

Tables 5 to 6.

### Dispersibility

Dispersibility was evaluated based on the mass of a component (non-filtered coarse particles) remaining on the filter in the filtration treatment in preparation of each of the inks of Examples 1 to 12 and Comparative Examples 1 to 9. A percentage (100×mass of coarse particle/mass of coloring particles) of the mass of the coarse particles relative to the mass of the coloring particles contained in the mixture before the filtration treatment was calculated. The calculation results were taken to be evaluation values for evaluation of dispersibility of the inks. The dispersibility of each ink was evaluated according to the following criteria.

### Criteria for Dispersibility

Very good (A): evaluation value of at least 0% by mass and no greater than 5% by mass

Good (B): evaluation value of greater than 5% by mass and no greater than 10% by mass

Poor (C): evaluation value of greater than 10% by mass

### Preservation Stability

Heating treatment at 60° C. for two weeks in an oven was performed on each of the inks of Examples 1 to 12 and Comparative Examples 1 to 9. Thereafter, filtration treatment was performed on the ink using a filter with a pore size of 5 μm. After the filtration treatment, the mass of a component (non-filtered coarse particles) remaining on the filter was measured. A percentage (100×mass of coarse particles/mass of coloring particles) of the mass of the coarse particles relative to the mass of the coloring particles contained in the ink before the filtration treatment was calculated. The calculation results were taken to be evaluation values for evaluation of preservation stability of the inks. The preservation stability of each ink was evaluated according to the following criteria.

### Criteria for Preservation Stability

Very good (A): evaluation value of at least 0% by mass and no greater than 5% by mass

Good (B): evaluation value of greater than 5% by mass and no greater than 10% by mass

Poor (C): evaluation value of greater than 10% by mass

### Textile Print Formation

As an evaluation apparatus, a test machine (product of KYOCERA Document Solutions Inc.) including a recording head (“KJ4B”, product of KYOCERA Corporation) was used. An evaluation target (any of the inks of Examples 1 to 12 and Comparative Examples 1 to 9) was charged in the recording head of the evaluation apparatus. A solid image with a size of 50 cm×50 cm was formed on a textile printing target (polyester Tetron pongee fabric) using the evaluation apparatus. Thereafter, heat treatment at 180° C. was performed on the textile printing target for 60 seconds. Through the above, the solid image was fixed to the textile printing target, thereby obtaining a textile print.

### Image Quality

Loupe observation and visual observation were performed on the solid image on the textile print to check the presence or absence of any image defects (specifically, image streak generation and image density irregularity). Image quality of the solid image on the textile print was evaluated according to the following criteria, and evaluation ratings 3, 4, and 5 were taken as acceptance and evaluation ratings 1 and 2 were taken as rejection. Note that the image streaks are generated due to clogging of nozzles of the recording head or ink ejection from the recording head toward an incorrect location.

### Criteria for Image Quality

Evaluation rating 5: no image defects recognized in both loupe observation and visual observation

Evaluation rating 4: a slight image defect recognized in loupe observation while no image defects recognized in visual observation

Evaluation rating 3: a definite image defect recognized in loupe observation while no image defects recognized in visual observation

Evaluation rating 2: a definite image defect recognized in loupe observation and a slight image defect recognized in visual observation

Evaluation rating 1: a definite image defect recognized in both loupe observation and visual observation

### Color Fastness to Rubbing

Color fastness to rubbing of the textile print with the solid image formed thereon was measured in accordance with the color fastness rubbing tester type II (Gakushin Type) method prescribed in the Japanese Industrial Standards (JIS) L-0849:2013 (Test methods for colour fastness to rubbing).

Specifically, two test pieces with a size of 220×mm×30 mm was cut out from an area of the textile print in which the solid image has been formed. One of the test pieces was used to evaluate color fastness to dry rubbing while the other test piece was used to evaluate color fastness to wet rubbing.

### (Color Fastness to Dry Rubbing

In evaluation of color fastness to dry rubbing, the central part of the test piece having a size of 100 mm was rubbed back and force 1000 times using a dry white cotton rubbing cloth at a rate of 30 times per minute (rubbing test). In the rubbing test, a load of 2 N was applied to the white cotton rubbing cloth. Next, the degree of being colored of the white cotton rubbing cloth after the rubbing test was evaluated in accordance with the “Criteria for discoloration and fading” prescribed in Section 10 (Determination of Degree of Colour Fastness) of JIS L-0801:2011 (General principles of tenting methods for colour fastness). The degree of being colored of the white cotton rubbing cloth was rated on 9 levels (in order of decreasing degree of contamination: 1, 1.5, 2, 2.5, 3, 3.5, 4, 4.5, and 5). The color fastness to dry rubbing is better as the degree of being colored of the white cotton rubbing cloth is smaller (close to level 5).

### Color Fastness to Wet Rubbing

Evaluation of color fastness to wet rubbing was performed according to the same method as that for evaluation of color fastness to dry rubbing in all aspects other than the following changes. In the evaluation of color fastness to wet rubbing, a white cotton rubbing cloth sufficiently moistened with water was used instead of the dry white cotton rubbing cloth. Furthermore, in the evaluation of color fastness to wet rubbing, the degree of being colored of the white cotton rubbing cloth was evaluated after the white cotton rubbing cloth was sufficiently dried by air blowing after the rubbing test.

Color fastness to rubbing of the textile print was evaluated to be good if the degree of being colored of the textile print was rated at level 3 or higher (level 3, 3.5, 4, 4.5, or 5) for each of color fastness to dry rubbing and color fastness to wet rubbing and evaluated to be poor if it was rated at any other level for at least one of color fastness to dry rubbing and color fastness to wet rubbing.

TABLE 5

| | | Example | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Dispersibility | | A | B | A | A | A | A | B | A | A | A | A | A |
| Preservation stability | | A | B | A | A | A | A | B | A | A | A | A | A |
| Image quality | | 4 | 5 | 4 | 5 | 4 | 4 | 4 | 4 | 5 | 5 | 5 | 5 |
| Color fastness | Dry | 4 | 4.5 | 4 | 4 | 4 | 4 | 4.5 | 4 | 3.5 | 4 | 4.5 | 4.5 |
| to rubbing | Wet | 3.5 | 4 | 3 | 3 | 3.5 | 4 | 4 | 3 | 3 | 3.5 | 4 | 3.5 |

TABLE 6

| | | Comparative Example | | | | | | | | |
|---|---|---|---|---|---|---|---|---|---|---|
| | | 1 | 2 | 3 | 4 | 5 | 6 | 7 | 8 | 9 |
| Dispersibility | | A | C | B | A | B | A | B | A | A |
| Preservation stability | | A | — | B | C | B | A | B | A | A |
| Image quality | | 4 | — | 5 | 2 | 1 | 1 | 2 | 4 | 5 |
| Color fastness | Dry | 4 | — | 2.5 | 4 | 2.5 | 4 | 3 | 2.5 | 3.5 |
| to rubbing | Wet | 2 | — | 2 | 4 | 1.5 | 2 | 2.5 | 1.5 | 2.5 |

The inks of Examples 1 to 12 each contained an aqueous medium, coloring particles dispersing in the aqueous medium, and a first cross-linking agent having a carbodiimide group. The coloring particles contained a specific vinyl resin and a specific salt compound containing a dye. The specific vinyl resin included a specific repeating unit derived from a specific monomer having a carboxy group. The specific vinyl resin had an acid value of at least 50 mg KOH/g and no greater than 150 mg KOH/g. The specific vinyl resin had a glass transition point (Tg) of at least 50° C. and no higher than 80° C. The inks of Examples 1 to 12 each had a percentage content of a free resin of greater than 0.00% by mass and no greater than 0.50% by mass. The inks of Examples 1 to 12 each had a percentage content of a free dye of greater than 0.000% by mass and no greater than 0.050% by mass. Each of the inks of Examples 1 to 12 was excellent in dispersibility and preservation stability, an image formed with the ink had excellent image quality, and a textile print formed with the ink had excellent color fastness to rubbing.

By contrast, the ink of Comparative Example 1 had an acid value of the specific vinyl resin of greater than 150 mg KOH/g. It is thought that the coloring particles of the ink of Comparative Example 1 had excessively high hydrophilicity due to the ink having an excessively high acid value of the specific vinyl resin. As a result, a textile print with not so excellent color fastness to rubbing (especially, color fastness to wet rubbing) was formed with the ink of Comparative Example 1.

The ink of Comparative Example 2 had an acid value of the specific vinyl resin of less than 50 mg KOH/g. It is thought that the coloring particles of the ink of Comparative Example 2 had excessively low hydrophilicity due to the ink having an excessively low acid value of the specific vinyl resin. As a result, the ink of Comparative Example 2 had poor dispersibility.

The specific vinyl resin of the ink of Comparative Example 3 had a glass transition point (Tg) of greater than 80° C. It was difficult for the coloring particles of the ink of Comparative Example 3 to fix to a textile printing target due to the specific vinyl resin thereof having an excessively high glass transition point (Tg). As a result, a textile print with not so excellent color fastness to rubbing was formed with the ink of Comparative Example 3.

The specific vinyl resin of the ink of Comparative Example 4 had a glass transition point (Tg) of less than 50° C. The coloring particles of the ink of Comparative Example 4 were soft even at room temperature due to the specific vinyl resin thereof having an excessively low glass transition point (Tg). As a result, the ink of Comparative Example 4 had poor preservation stability.

The ink of Comparative Example 5 had a percentage content of the free dye of greater than 0.050% by mass. The ink of Comparative Example 6 had a percentage content of the free resin of greater than 0.50% by mass. Due to the inks of Comparative Examples 5 and 6 excessively containing the free dye or the free resin, images formed with either of the inks had poor image quality. Furthermore, a textile print with not so excellent color fastness to rubbing was formed with either of the inks of Comparative Examples 5 and 6.

The ink of Comparative Example 7 contained coloring particles containing a disperse dye instead of containing coloring particles containing a specific salt compound. As for the ink of Comparative Example 7, it is thought that the disperse dye was insufficiently dispersed in the specific vinyl resin in the coloring particles. As a result, a textile print with not so excellent color fastness to rubbing was formed with the inks of Comparative Example 7. Furthermore, an image formed with the ink of Comparative Example 7 had poor image quality.

As for each of the inks of Comparative Examples 8 and 9, it is thought that the coloring particles were insufficiently cross-linked due to the ink not containing the first cross-linking agent. Therefore, it is determined that the coloring particles were insufficiently fixed to the surface of the textile printing target in a textile print formed with either of the inks of Comparative Examples 8 and 9. Furthermore, it is determined that the coloring particles of the inks of Comparative Examples 8 and 9 remained high in hydrophilicity even after the textile printing. As a result, a textile print with not so excellent color fastness to rubbing (especially, color fastness to wet rubbing) was formed with either of the inks of Comparative Examples 8 and 9.

What is claimed is:

1. An inkjet textile printing ink comprising:
an aqueous medium;
coloring particles dispersing in the aqueous medium; and
a first cross-linking agent having a carbodiimide group, wherein
the coloring particles contain a specific vinyl resin and a specific salt compound containing a dye,
the specific vinyl resin includes a specific repeating unit derived from a specific monomer having a carboxy group,
the specific vinyl resin has an acid value of at least 50 mg KOH/g and no greater than 150 mg KOH/g,
the specific vinyl resin has a glass transition point of at least 50° C. and no higher than 80° C.,
the inkjet textile printing ink does not comprise a free resin dispersing or dissolving in the aqueous medium or has a percentage content of the free resin of greater than 0.00% by mass and no greater than 0.50% by mass, and
the inkjet textile printing ink does not comprise a free dye dispersing or dissolving in the aqueous medium or has a percentage content of the free dye of greater than 0.000% by mass and no greater than 0.050% by mass.

2. The inkjet textile printing ink according to claim 1, wherein
the specific vinyl resin is a block copolymer of a first block and a second block, the first block including the specific repeating unit, the second block not including the specific repeating unit.

3. The inkjet textile printing ink according to claim 1, wherein the dye includes a basic dye.

4. The inkjet textile printing ink according to claim 1, further comprising a second cross-linking agent that is a block isocyanate.

5. The inkjet textile printing ink according to claim 1, further comprising a neutralizer, wherein
the neutralizer contains an amine compound.
